(19) United States
(12) Patent Application Publication
(10) Pub. No.: US 2007/0075586 A1
(43) Pub. Date: Apr. 5, 2007

(54) Ethernet powered device with an internaly controlled auxiliary power ouput

(76) Inventor: Edward M. Bogue, Colchester, CT (US)

Correspondence Address: EDWARD M. BOGUE, 155 AMSTON RD., COLCHESTER, CT, 06415, US

(21) Appl. No.: 11/243,201

(22) Filed: Oct. 5, 2005

(51) Int. Cl. H02J 9/00

(52) U.S. Cl. 307/66

(57) ABSTRACT

A powered device (PD) designed to connect to an ethernet cable, which has an auxiliary power port capable of powering a load and switching on and off. In an access control application this auxiliary power port could be connected to an electric door strike. This would eliminate the need for a separate power supply for the door strike and thus, a simplified installation process. This invention would also allow the ethernet powered device (PD) to control and power the load, which would allow the power sourcing equipment (PSE) remote sensing of the power consumed, thus determining if the load is in failure mode. By allowing the powered device (PD) to source power for itself and to provide an auxiliary power output, the power sourcing equipment PSE can be used to detect faults in the load. The power sourcing equipment (PSE) can monitor the current consumed by the PD, and the system can detect if the PD is not drawing sufficient current when the auxiliary power port is activated. If the current is determined to be below a predetermined threshold level, an alert can be issued indicating a broken connection in wires connecting the PD to the load or an open circuit in the load itself.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### BACKGROUND OF INVENTION

This invention relates to ethernet POE devices, specifically one capable of providing power output to other devices.

### BACKGROUND

The invention has particular reference to devices powered over networking cable, including ethernet cable, and which are referred to as “powered devices” or “PD” herein.

The invention has particular reference to devices providing power over networking cable, including ethernet cable, and which are referred to as “power sourcing equipment” or “PSE” herein.

The invention has particular reference to networks, including ethernet, and which are referred to as “ethernet” herein.

This invention has particular reference to devices used to electro-mechanically or electro-magnetically control a door or turnstile, and which are referred to as “door strike” herein.

Ethernet cable has been used for many years for connecting different computing type devices together, including servers, PCs, and printers. As technology progressed other types of devices were connected to the ethernet network such as telephones and time clocks. There also have been a number of different standards designed for powering these devices over the ethernet cable. Recently the IEEE 802.3af standard was developed and accepted by most manufacturers of PSE and PD equipment as a universal standard for power over ethernet. The standard implementation of a powered over ethernet system (POE) may include telephones or credit card readers set up as a PD. One such example of a telephone powered over ethernet is U.S. Pat. No. 6,115,468.

In most case a PSE in a system performs two functions. The first function is as an ethernet switch, the second function as a device that can supply power over the ethernet cabling. With regard to the power supply function, the PSE in an IEEE 802.3af system has become more sophisticated than just being a power supply. Before supplying a significant amount of power to the ethernet cable, the PD must present a compatible load on the line to “inform” the PSE it is a compliant device and how much power needs to be allocated. The PD may be plugged into an ethernet outlet that indicates power is present, such as described in U.S. Pat. No. 6,448,899. Each port on the PSE can be controlled independently with a priority masking set up in cases where insufficient power is available for all devices present on the system.

An access control system can be implemented a couple of different ways: an online system or a stand-alone system. In the online system all decisions concerning scheduling, recording of ID presented to the ID input device, decision to allow access, and time and date stamping are done in a device on a remote computer or server. The ID input device can be a barcode, magnetic stripe, RF ID tag, fingerprint or any of the various other types of means used to identify people or items. One example of a swipe style access control device is U.S. Pat. No. 6,929,175, which describes a swipe style reader. U.S. Pat. No. 6,422,463 describes an access control system where the controller allows for external inputs and a door-unlock signal. The stand-alone systems perform basically the same functions as the online systems except all functions are contained in one unit, and the units are able to function without the need for any external control. Almost all types of access control controllers have some sort of an output that can control a door; the most common is an isolated form C relay. Form C relay is a type of relay with a normally open contact, normally closed contact, and a common contact. The door strike has two common configurations: fail-safe and fail-secure. The fail-safe strike will allow the door to remain open when power is removed, thus requiring power to lock the door. The fail-secure strike will allow the door to remain locked when power is removed, thus requiring power to unlock the door.

### BRIEF SUMMARY OF INVENTION

This invention allows a power over ethernet powered device to internally control and power an auxiliary power port. This would allow for a system that eliminates the need for an additional power supply for the load and leads to more simplified wiring. Another benefit would be the ability for the PSE to remotely sense the power consumed by the load. For simplicity, this invention will use an access control application as an example. The most common load in access control will be an electric door strike that is connected to this power port. By indirectly allowing the PSE to remotely sense power consumption of the door strike, a computer connected to the PSE could determine if the electric strike is in a state of failure.

In a system that has the PSE supplying power to a PD, the PSE could be made to sense all power consumed by the PD or many PDs on different ports. This ability to sense the power consumed by the PD would allow any server with access to the PSE's data to monitor the power consumption of all different parts of the system. The power consumed by a PD controlling a door strike will be predictable if the internal states of the PD are known. Because the PD is an ethernet device, its internal state can either known by a computer controlling it over the network, or it can be queried over the network to determine its internal states. Thus the power consumed by the PD should be predictable. The PSE could use this information to verify the power consumed by the PD is indeed within specifications for its given state in order to determine if the PD is working properly.

A PD with an internally switched power output port can be used to power an electric door strike. The most common voltage for an electric door strike is 12-volts; therefore this should be the output voltage for the auxiliary port in this example. Because the IEEE 802.3af standard specifies a nominal voltage of 48 volts, the power supplied to the auxiliary power port must be regulated down to the 12-volt level and this can be conveyed across the board to the auxiliary power output port. This conversion from 48 volts to 12 volts will be done using a power regulator internal to the PD. If the door strike is connected to this power output port in a manner which all significant power consumed by the door strike is derived from the power output port, a PSE supplying power to the PD will also power the door strike. A computer, which has access to the network containing the PSE, can now measure the power consumed by the PD and the door strike combined. By subtracting the calculated power consumed by the PD from the total power supplied by the PSE, the power consumed by the door strike can be inferred. When the inferred power consumed by the door strike is out of a predefined tolerance, the door strike can be assumed to be in failure mode. If too little power is consumed, the door strike may be in open circuit failure or may have been tampered with. If too much power is consumed, it could be deduced the door strike may short-circuit or may have been tampered with.

### BRIEF DESCRIPTION THE DRAWINGS

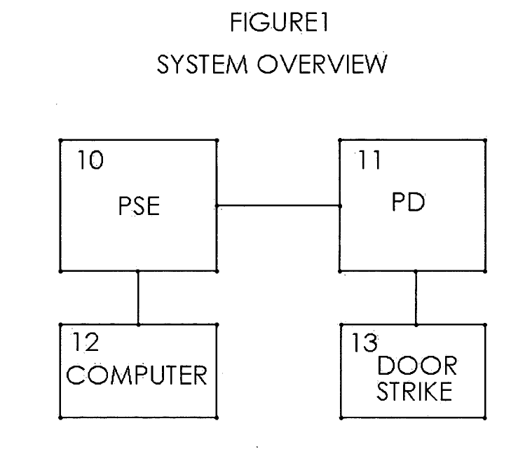

FIG. 1: This diagram shows the relationship between the different parts of the system:
10 Power sourcing equipment (PSE)
11 Powered device (PD)
12 Computer
13 Door strike

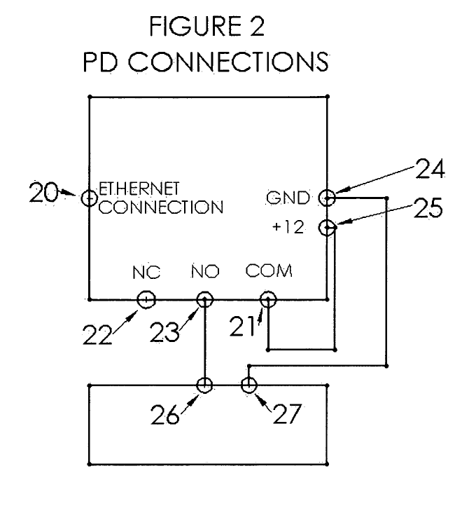

FIG. 2: This diagram shows the connections for the powered device containing a relay.
20 Ethernet connection
21 Relay common
22 Relay normally closed
23 Relay normally open
24 Auxiliary power port ground
25 Auxiliary power port +12 volts
26 Door strike connection A
27 Door strike connection B

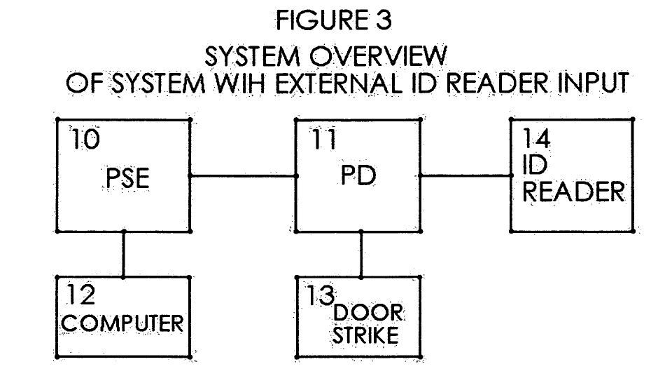

FIG. 3: This diagram shows the relationship between the different parts of the system where the PD includes a port for connection to an external identification reader.
10 Power sourcing equipment (PSE)
11 Powered device (PD)
12 Computer
13 Door strike
14 ID Reader

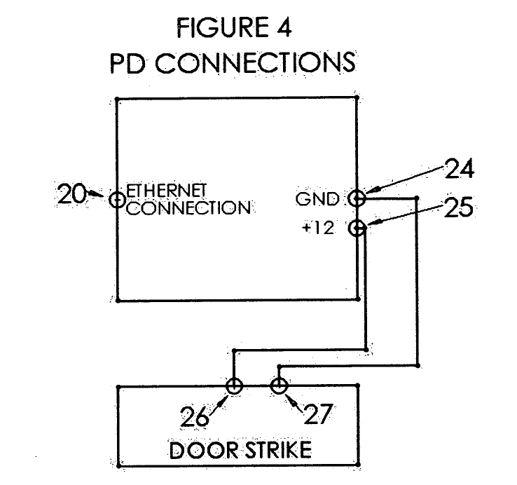

FIG. 4: This diagram shows the detailed connections for the powered device.
20 Ethernet connection
24 Auxiliary power port ground
25 Auxiliary power port with switched +12 volts
26 Door strike connection A
27 Door strike connection B

### DETAILED DESCRIPTION OF THE INVENTION

### Preferred Embodiment

Powered device with auxiliary power output (FIG. 1,2)

Description of Invention

FIG. 1 shows an example of a system implementing a Powered Device (PD) (11) capable of powering and controlling a door strike (13). The PD (11) will often have a built in identification input device such as a barcode, RF card, or fingerprint reader. The Power Sourcing Equipment (PSE) (10), is typically a server or switch, which is Power Over Ethernet (POE) compliant. The host computer (12), is a typically a standard computer or server which is connected to the PSE (10) via ethernet cable. The Powered device (PD) (11), is connected to a port on the PSE (10) via ethernet cable. The Powered device (PD) (11), is connected to the door strike (13) via wiring of sufficient size to carry the voltage and current specified by the particular door strike (13). The door strike (13) would typically be installed in a fashion to control access of a door or turnstile.

FIG. 2 shows some of the connections required for the PD (11). The ethernet connection (20) is typically a RJ45 style jack into which the ethernet connection is made. The relay connections are a standard form C relay: relay common (21); relay normally open (22); and relay normally closed (23). The auxiliary power port ground (24) and the auxiliary power port +12 volts (25) provide 12-volt power output. The door strikes connection A (26) is shown connected to the relay normally open (22). Door strike connection B (27) is shown connected to the auxiliary power port ground (24). There is a jumper wire connecting the auxiliary power port +12 volts (25) to the relay common (21).

Operation of Invention

In this invention the PD (11) will provide sufficient power to the auxiliary power port (24,25) to operate the door strike (13) by enabling and disabling the port. Door strike (13) operation would typically be trigger by an action such as an ID card being scanned. The PSE (10) will provide all the power for the PD (11). The PSE (10) should also be the type, which is capable of reporting the power consumed on each port via ethernet or serial connection to the host computer (12).

Contained within the PD (11) is a micro-controller or microprocessor. This controller or processor will control the relay or power supplied to the auxiliary power port and is capable of communication to the host via the ethernet network. The reported states should include, but not limited to, the state of the relay, and any other internal or other auxiliary controlled devices. The PD (11) should be capable of reporting all of its states in response to a query via the ethernet connection (20). The purpose of reporting the internal states is to determine the theoretical power consumed so, the state of any subassembly of the PD (11) or external port which can have a varying power requirement should be included in this state report. The PSE (10) will provide the power and communications to the PD (11) via the POE cabling.

The computer, which is connected to the system, can now request the status of the PD (11). Upon design or installation of the system the power consumed by all combination of states could be measured and stored in a computer database. With the status of the PD (11) known, the computer can use the predefined database to determine the theoretical power consumed by the PD (11) in any given state. If the power consumed is within a predetermined tolerance, the system is considered within specifications. If the power consumption is considered outside of the predetermined tolerance, the system is considered to be in possible failure mode. One of the most likely causes of an out of specification power consumption is the door strike (13) to be drawing the incorrect amount of power. If the power consumed is too high, the windings for the door strike (13) may have short circuited, causing the effective resistance to be lowered. If the power consumed is too low the door strike may have an open circuit on the windings, the door strike (13) may have a faulty interconnection, or an external connection may have broken or been tampered with. This power consumption based diagnostics can be very simple to implement with no additional cost.

In some installations it may not be required for the PD (11) to be capable of reporting its internal states. One such example is where the computer (12) would send a test configuration the PD (11), which would leave the computer able to calculate the theoretical power consumed. Another possibility is where the computer (12) is in control of all significant power consuming functions of the PD (11). In this case the computer (12) could internally track the internal states of the PD (11) and calculate the theoretical power consumed.

The auxiliary power output's GND (24) and +12 volt output (25) could be powered continually or internally switched on and off using an internal switching mechanism. The relay can also be switched for momentary changes in its state. By allowing for an external or internal jumper to connect +12 volt (25) to the relay common contact (21), the PD (11) can have the auxiliary power port capable of being switched on and off. Having an isolated form C relay will also give the flexibility of not using the internally generated +12 volts (25) to control a door strike if the voltage required or the power consumed by the door strike is greater than the PD can supply. In this case the relay switching mechanism can be used as a standard isolated relay for use with an external power supply.

### ALTERNATIVE EMBODIMENT

System Overview with External Reader Input (FIG. 3)

This embodiment of the invention is similar to the previous example, except the internal ID reader on the PD (11) has been replaced with an additional port allowing for a badge reader compatible input. This additional port may also supply power to the ID reader if desired. The badge reader (14) is connected to the PD (11) via acceptable cabling. This configuration allows the PD (11) to accept varied ID verification types and is more tamper resistant by physically separating the user interface from the door strike's (13) control wires.

### SECOND ALTERNATIVE EMBODIMENT

PD with Switch Power Output (FIG. 4)

This embodiment of the invention is similar to the first example, except the requirement to jumper the auxiliary power output to the to the form C relay is eliminated. The auxiliary power output port should not be energized at all time, but rather only when the door strike (13) requires power for access or access restriction. This switching of the auxiliary power output port on and off could be implemented internally through solid-state means or a standard mechanical relay. The advantage of this configuration is simplified wiring in the installation process and increased tamper resistance.

### THIRD ALTERNATIVE EMBODIMENT

PD with Built in Diagnostics

This embodiment of the invention is similar to the first example, except the diagnostics are contained within the PD (11). In this embodiment the tracking of the configuration states within the PD (11) and the theoretical power drawn from the system being in such a state, is done entirely within the PD (11). The PD (11) can then query the PSE (10) through the ethernet network to the power consumed by the PD (11). If the power consumed is outside predetermined parameters, an error indicator could be displayed on the PD (11) if indicators are available, and an error code could be sent to the main host computer.

### CONCLUSION

Accordingly, the reader will see the ethernet-powered device in this invention will:
Enhance a systems ability to perform unobtrusive self-diagnosis.
Enhance the systems ability to detect tampering for unauthorized access.
Increase the systems reliability by reducing the number of power supplies.
Simplify installation by reducing the amount of wiring required in an access control system.

Although the description above contains many specifications, these should not be construed as limiting the scope of the invention, but merely providing illustrations of some of the presently preferred embodiments of this invention.

There are some of the many other variations possible for implementing this invention:
The type of network is not limited to ethernet, but can be any type of wired network capable of supplying power and carrying data
Many different devices could be integrated into the Powered Device such as displays, keypads, or other indicators.
The type of id verification is not limited to those mentioned above. Any type or combination of types could be used
The device could have an additional port for attaching multiple remote id readers or any number or additional external devices, and provide power on multiple ports.
The auxiliary power output port should not be limited to use on a door strike or in access control applications.
The external jumper wire between the +12 volts output and the relay could be replaced with a built in switch or jumper.

Thus, the scope of the invention should be determined by the appended claims and their legal equivalents, rather than by the examples given.

I claim:

1) A ethernet powered device which provides a means of
a) being powered over ethernet cable, and
b) receiving data from said ethernet cable and,
c) providing an auxiliary power output whereby the power available to said auxiliary power output is provided by a power regulator contained within said powered device.

2) The device in claim 1 where said powered device provides means for power on said auxiliary power output to be enabled and disabled.

3) The device in claim 2 where the switching mechanism for said auxiliary power output is a relay.

4) The device in claim 1 where the device provides a means of reporting its internal states via said ethernet cable.

5) The device in claim 1 where the device is also an id input device.

6) The device in claim 1 where the device is capable of providing an auxiliary power output of sufficient power to control an electric door strike.

7) The device in claim 1 which provides a means for power consumption based diagnostics.

8) A powered device which includes
a) electronics which provide conveyance of power from an ethernet port to a microprocessor contained within said powered device, and
b) electronics capable of receiving data from said ethernet port and,
c) electronics which provide conveyance of power from an ethernet port to an auxiliary power output contained within said powered device, and
d) a switching mechanism which can be electrically connected to said auxiliary power output.

9) The device in claim 8 where the switching mechanism for said auxiliary power output is a relay.

10) The device in claim 8 which includes electronics capable of reporting its internal states via ethernet cable.

11) The device in claim 8 where the device includes an id input device.

12) The device in claim 8 where said auxiliary power output provides sufficient power to control an electric door strike.

13) A device providing means for controlling door access which includes
a) a switched auxiliary power output, and
b) sufficient electronics to receive data via ethernet cabling and,
c) a connection for receiving power from said ethernet cable, and

14) The device in claim 13 which provides a means for switching said auxiliary power output.

15) The device in claim 14 where the switching mechanism for said auxiliary power output is a relay.

16) The device in claim 13 which provides a means for reporting its internal states via said ethernet cable.

17) The device in claim 13 which includes an id input device.

18) The device in claim 13 which includes an auxiliary power output capable of sufficient power to control an electric door strike.

19) The device in claim 13 which provides a means for power consumption based diagnostics.
